(19) United States
(12) Patent Application Publication
(10) Pub. No.: US 2016/0288446 A1
(43) Pub. Date: Oct. 6, 2016

(54) METHOD AND APPARATUS FOR TREATING CONTINUOUS SHEET MATERIAL

(71) Applicant: PHILIP MORRIS PRODUCTS S.A., Neuchâtel (CH)

(72) Inventors: Daniele Sanna, Bologna (IT); Diego Ferrazzin, Modena (IT)

(21) Appl. No.: 15/029,861

(22) PCT Filed: Dec. 22, 2014
(86) PCT No.: PCT/EP2014/078951

§ 371 Date: Apr. 15, 2016

(30) Foreign Application Priority Data
Dec. 23, 2013 (EP) 13199457.6

(51) Int. Cl. B31F 1/18; A24D 3/10; B31D 5/04; A24D 3/02; B31F 1/12; B31D 5/00

(52) U.S. Cl. CPC B31F 1/18; B31F 1/122; B31D 5/0082; B31D 5/04; A24D 3/0204; A24D 3/10

(57) ABSTRACT

The method for treating continuous sheet material for use in the manufacture of rod-shaped articles comprises the steps of providing a continuous sheet material comprising a crimping structure running in a longitudinal direction of the continuous sheet material. It further comprises the step of providing a first roller and a second roller, the first roller and the second roller comprising a plurality of circumferentially running cams, the circumferentially running cams of the first roller and the circumferentially running cams of the second roller engaging each other. The method further comprises the step of guiding the continuous sheet material comprising the crimping structure between the circumferentially running cams of the first roller and of the second roller. Thereby the continuous sheet material comprising the crimping structure is provided with a wave [symbol] like structure, the wave-like structure runs in a longitudinal direction of the continuous sheet material and overlays the crimping structure.

The present invention relates to methods and apparatuses for treating continuous sheet material. Especially, it relates to treatment of continuous sheet material for use in the manufacture of rod-shaped articles, for example filter elements for smoking articles.

For manufacturing filter elements, generally a flat continuous sheet material is pushed into a circularly shaped rod, which rod may then be into individual filer elements. These rod-shaped filter elements have an internal structure of essentially random order. However, the material of the filter element and especially its arrangement in the filter element may influence the filter quality and its reproducibility.

There is a need for a method and apparatus for treating sheet material for use in the manufacture of rod-shaped articles, which take into account disadvantages of prior art methods. Especially, there is a need for such methods and apparatuses which allow for the production of filter elements for smoking articles having a good reproducibility.

According to one aspect of the invention there is provided a method for treating continuous sheet material for use in the manufacture of rod-shaped articles such as for example filter elements for smoking articles. The method comprises the step of providing a continuous sheet material comprising a crimping structure, the crimping structure running in a longitudinal direction of the continuous sheet material. It further comprises the step of providing a first roller and a second roller. The first roller and the second roller comprise a plurality of circumferentially running cams. The circumferentially running cams of the first roller and the circumferentially running cams of the second roller engage each other. A further step comprises guiding the continuous sheet material comprising the crimping structure between the circumferentially running cams of the first roller and of the second roller. Thereby, the continuous sheet material comprising the crimping structure running in the longitudinal direction is provided with a wave-like structure running in a longitudinal direction of the continuous sheet material and overlaying the crimping structure. Due to the wave-like structure being arranged in a longitudinal direction of the continuous sheet material (the longitudinal direction also corresponding to a direction of transport of the continuous sheet material), the sheet material comprising the crimping structure and comprising the wave-like structure may then be folded or pushed together in a transversal direction of the sheet material (or transversal direction to a direction of transport of the sheet material) according to the wave-like structure. The wave-like structure defines the way the sheet material folds upon being pushed together. The overlaying wave-like structure has dimensions in a direction perpendicular to a plane spanned by the sheet material which dimensions are at least in this perpendicular direction larger than the dimensions of the crimping structure in said perpendicular direction.

When performing the treatment method, the continuous sheet material is guided between the first and the second rollers and thus between the circumferentially running cams of the first and the second rollers. The engaging cams force the continuous sheet material into a wave-like form defined by the cams when the sheet material passes between the two rollers. Thereby, the wave-like structure is imposed on and created in the continuous sheet material, which wave-like structure overlays the crimping structure already present in the sheet material. Upon providing the sheet material with the wave-like structure, the sheet material is already being folded to a certain extent along the width of the sheet material. When further being folded, the sheet material follows the wave-like structure and is further reduced in width by being pushed together in a transversal direction. The sheet material is pushed together to a final, for example circular, shape. Randomness occurring when folding crimped sheet material into a rod-like shape may at least partly be replaced by a predefined and organized structure given by the wave-like structure. A well-defined structure represents a consistent specification or quality of the so produced article, for example a constant resistance to draw per length of a filter element. In addition, the creation of a well-defined structure in the filter element also allows for a high reproducibility of filter elements with equal specifications. This is especially favourable when manufacturing short filter elements. In short filter elements, irregular structures may have a more prominent effect on a filter specification than in long filter elements, where irregularities may be compensated at least to some extent. The folding of the sheet material is additionally supported by the crimping structure. The crimping structure, which is also arranged in longitudinal direction, facilitates the folding or pushing together of the sheet material transversal to the longitudinal direction of the sheet material. In addition, the crimping structure supports the creating of longitudinal channels between the folds of the sheet material and along the folded sheet material. Thus, with the crimping structure basically following the wave-like structure the manufacture of reproducible products is further supported.

The two rollers provided with cams act on the sheet material in a localized manner. The cams of the rollers act essentially along a line only, which line extends across the width of the sheet material. By this, upon structuring the sheet material, stress on the material may be kept at a minimum—temporally and locally. Therefore, also fragile materials with for example a low tensile strength may be provided with an overlaying structure. This allows the use of a wide variety of materials for the production of rod-shaped elements having a structure of high order. In addition, due to the small and short time contact of the cams with the sheet material upon structuring the sheet material and due to the fact that the cams are rolled while the sheet material passes between the rollers, an electrostatic charging of the material or a heating up of the sheet material while passing between the rollers may be kept at a minimum. Providing a continuous sheet material with a wave-like structure for a more controlled folding behaviour may be favourable when folding any kind of sheet material. However, it is especially favourable if plastic material or a material that does not easily hold its position when folded is to be brought into a rod-shape.

Preferably, the sheet material is a foil made of a plastic material, for example a sheet material made of or comprising a biopolymer such as polylactic acid (PLA) or a sheet material comprising a cellulose based material, for example paper or a tobacco containing material, for example a tobacco sheet. Alternatively, the sheet material may be a metallic foil or having layered structures such as laminates, comprising two or more layers selected from, for example, paper, cardboard, plastic or metal.

A wave-like structure is always running in a longitudinal direction of the continuous sheet material to allow folding of the sheet material in a transversal direction of the continuous sheet material. Therein, a wave-like structure may run in an exact longitudinal direction but also in longitudinal directions slightly varying from the exact longitudinal direction but still being an overlaying wave-like structure according to the invention.

A crimping structure may be provided in the sheet material to run in an exact longitudinal direction but also in longitudinal directions slightly varying from the exact longitudinal direction. A crimping structure may also be arranged exactly parallel to the wave-like overlying structure or may differ slightly from the exact same direction of the wave-like structure. Preferably, crimping structures have dimensions at least in a direction perpendicular to a plane spanned by the sheet material, which are smaller than the wave-like structure in this perpendicular direction. Preferably, the dimensions of the crimping structure perpendicular to the movement plane of the sheet material range below about 0.5 mm, more preferably below 0.3 mm, for example 0.2 mm. Preferably, lateral dimensions of the crimping structure, i.e. distances between individual crimps in the sheet material range below about 0.5 mm, more preferably below 0.3 mm, for example 0.2 mm. Preferably, a crimping structure is a regular structure, for example a structure of substantially parallel corrugations.

According to an aspect of the method according to the invention, providing the continuous sheet material comprising the crimping structure with a wave-like structure comprises providing the continuous sheet material with a wave-like structure having wave peak to wave trough dimension or height in the range of between about 10 mm and about 50 mm, preferably between about 15 mm and about 35 mm. Preferably, the wave-like structure describes a sinusoidal path. Preferably, the sinusoidal—or other shaped—path in a crimping apparatus has a length corresponding to the initial width of the sheet material to be provided with the wave-like structure. Preferably, a wavelength of the wave-like structure (peak-to-peak distance) is in the range of about 5 mm to about 40 mm, preferably between about 10 mm and about 25 mm.

Preferably, a peak to peak distance is measured from center to center of the peaks or from the highest point to highest point of the peaks. Preferably, a trough to trough distance is measured from center to center of the troughs or from the deepest point to deepest point of the troughs.

According to another aspect of the method according to the invention, the method comprises the step of providing the continuous sheet material comprising the crimping structure with a wave-like structure, which wave-like structure comprises an undulation of a highest possible order such that said sheet material comprising the crimping structure and comprising said wave-like structure after pushing together in accordance with the overlaying wave-like structure fits in a circle, for example at the entrance of an air-jet or a garniture tongue, which entrance circle has a cross section in a range of about 10 mm to about 60 mm, preferably in a range between about 5 mm to about 45 mm.

According to another aspect of the method according to the invention, the method further comprises the step of limiting a torsional movement of the continuous sheet material comprising the crimping structure and comprising the wave-like structure. By limiting a torsional movement or a rotation of the sheet material a final structure of the folded sheet material may further be influenced. By limiting the torsional movement, the already partly pushed together sheet material may not rotate and thereby may not twist off the (regular) wave-like structure. Thus, by limiting a torsional movement of the sheet material randomness in the arrangement of the sheet material in the final product may further be reduced. Thereby, a specification of the final product is further secured or positively influenced.

Limiting a torsional movement of the continuous sheet material may be performed by arranging guides, for example to each side of the sheet material. According to some preferred embodiments, limiting a torsional movement of the continuous sheet material is performed by guiding the continuous sheet material comprising the crimping structure and comprising the wave-like structure along and preferably between guiding beams, which guiding beams may act on a central portion of the continuous sheet material. Guiding beams arranged to act on a central portion of the sheet material not only limit or prevent a rotation of the sheet material during its passing along and preferably between the guiding beams but may also direct the sheet material into a desired direction. Such a desired direction may be given by a direction of the arrangement of the guiding beams. Preferably, the guiding beams are at least partly arranged above each other, preferably in a displaced alternating manner. The continuous sheet material is then guided between upper and lower guiding beam or beams. A distance between guiding beams (in any direction) is chosen to allow an essentially free passing of the sheet material along and between the guiding beams. By being guided between and along the guiding beams, and especially also be being guided along the guiding beams, essentially no force acts on the sheet material except for the guiding force and possibly a force pushing the sheet material further together according to the wave-like structure. By the guiding beams no force acts on the sheet material that might impose a further structure (next to the wave-like structure) onto the sheet material.

The term ‘central portion’ as used herewith includes all locations in the plane spanned by the sheet material, which locations are located more centrally than the lateral side edges of sheet material. Preferably, a ‘central portion’ comprises a central longitudinal axis of the sheet material.

According to some aspects of the method according to the invention, the method further comprises the step of reducing the width of the sheet material upon performing the step of limiting the torsional movement of the sheet material. Thereby, upon limiting the torsional movement, the sheet material is further pushed together and further brought into its final shape. Preferably, a reduction in width of the sheet material is performed in a continuous manner. By this the width is reduced with a continuous movement avoiding abrupt changes in the transport direction of the sheet material and thus stress in the sheet material. For example, if guiding beams limiting a torsional movement are arranged in a converging manner, converging versus a direction of transport of the sheet material, the sheet material is, while being guided, also further folded and hence reduced in width. For example, also with an arrangement of guiding beams having a (lateral) distance to each other which distance is smaller than a wave peak to wave peak distance of the wave-like structure, a further reduction of the width of the sheet material may be achieved.

According to another aspect of the method according to the invention, the method further comprises the step of feeding the continuous sheet material comprising the crimping structure and comprising the wave-like structure into a rod making machine, preferably into a garniture tongue of a rod making machine. When feeding the sheet material into a rod making machine, the already partly pushed together material is further folded according to the wave-like structure and brought into its final rod-shape. Due to the overlaying wave-like structure, the folding from a more or less pushed together continuous sheet material into a rod-shaped article may in the rod making machine be performed in a controlled manner.

According to a further aspect of the method according to the invention, a continuous sheet material made of a plastic material is provided. A plastic material may for example be cellulose acetate, for example a PLA (polylactic acid) foil. A well-defined folding structure as may be given by the overlaying wave-like structure, for example also including a limitation of a torsional movement, is especially favourable when used in combination with plastic material. Plastic materials, but also other sheet materials, are often reluctant of being folded or bent in a form different to an initial form, which in the present invention essentially is a flat sheet form. However, the method according to the invention is also applicable to other sheet materials, which shall be brought from a flat into a three dimensional shape having a well-defined structure. Preferably, a three dimensional shape has a form with circular or oval cross-section, without being limited thereto.

According to another aspect of the invention there is provided an apparatus for treating continuous sheet material comprising a crimping structure for use in the manufacture of rod-shaped articles such as for example filter elements for smoking articles. The apparatus comprises a first roller and a second roller. The first roller and the second roller each comprise a plurality of circumferentially running cams. Further, the first roller and the second roller are arranged to enable the circumferentially running cams of the first roller and the circumferentially running cams of the second roller to engage each other. By this the continuous sheet material comprising the crimping structure may be provided with a wave-like structure overlaying the crimping structure and running in a longitudinal direction of the continuous sheet material upon guiding the continuous sheet material comprising the crimping structure between the circumferentially running cams of the first roller and the circumferentially running cams of the second roller.

The advantages of the aspects of the apparatus according to the invention have already been discussed in connection with the corresponding aspects of the method, so that they are not discussed again.

Preferably, the circumferentially running cams of each of the plurality of circumferentially running cams of the first and the second roller are arranged at an equal distance to each other and parallel to each other. Preferably, the first and second rollers are arranged such that the circumferentially running cams lie in planes parallel to a direction of transport of the sheet material. The first roller and the second roller are further arranged to enable the continuous sheet material to pass between the cams of the first and second rollers such as not blocking the transport of the sheet material but to provide enough force or pressure upon the sheet material to impose the form of the cams onto the material.

According to an aspect of the apparatus according to the invention a gap of a constant width is arranged between the circumferentially running cams of the first roller and the circumferentially running cams of the second roller. The width of the gap for a cellulose acetate material, such as a PLA (polylactic acid) foil, is preferably in a range between about 0.2 mm and about 3 mm, more preferably between about 0.25 mm and about 2 mm, for example between 0.5 mm and 1.5 mm.

A polylactic acid foil may have a thickness in a range of between about 10 microns and about 150 microns, preferably 50 microns plus or minus 5 microns. Preferably, a continuous sheet material has a width of between about 150 mm and about 270 mm.

As a general rule, whenever the term “about” is used in connection with a particular value throughout this application this is to be understood such that the value following the term “about” does not have to be exactly the particular value due to technical considerations. However, the term “about” used in connection with a particular value is always to be understood to include and also to explicitly disclose the particular value following the term “about”.

Depending on the kind and thickness of the sheet material to be provided with a wave-like structure and the size of the crimping structure already comprised in the sheet material, a gap size may be chosen and adapted accordingly. For example, in a gap of non-constant width a region between wave peaks of the cams of one roller and wave troughs of the corresponding cams of the other roller may be smaller than the regions between peaks and troughs to facilitate a folding of the sheet material in the region of the wave peaks of the so formed wave-like structure.

According to another aspect of the apparatus according to the invention, a distance between neighbouring circumferentially running cams of the first roller ranges between about 5 mm and about 40 mm, preferably between about 15 mm and about 25 mm. Preferably, a length of the circumferentially running cams of the first roller ranges between about 10 mm and about 50 mm, more preferably between about 15 mm and about 35 mm. In preferred embodiments, a distance between neighbouring circumferentially running cams of the second roller and a length of the cams of the second roller range within the same parameters as defined for the first roller.

According to another aspect of the apparatus according to the invention, the apparatus further comprises guiding beams. The guiding beams are arranged with their longitudinal axes in a direction of transport of the continuous sheet material for guiding of the continuous sheet material comprising the crimping structure and comprising the overlaying wave-like structure along the guiding beams in the direction of transport, thereby limiting torsional movement of the sheet material. Preferably, the wave-like structure passes along the guiding beams, for example by one or several curves of the wave-like structure passing along top sides of the guiding beams.

The guiding beams may further be arranged next to each other and at a preset distance to each other and with an offset perpendicular to a movement plane of the continuous sheet material. Thereby, neighbouring guiding beams have an offset in directions opposite each other to enable guiding of the continuous sheet material comprising the crimping structure and comprising the overlaying structure in between and along the guiding beams in a wave-like manner in the direction of transport.

The guiding beams are arranged downstream of the first and second roller, downstream in view of the direction of transport of the continuous sheet material. By this, the sheet material provided with the overlaying structure is guided before and while being brought into its final shape. The shape of the wave-like structure is supported or stabilized by the guiding beams. Guiding beams may especially limit or prevent a torsional movement of the sheet material. Preferably, the guiding beams enter into waves of the wave-like structure and at least partly take over the wave-like structure. Preferably, the guiding beams are arranged exactly in the direction of transport of the sheet material. However, also directions varying from an exact direction of transport support and guide a sheet material while being moved in the direction of transport.

According to another aspect of the apparatus according to the invention, the guiding beams are arranged with a distance between upstream ends of neighbouring guiding beams that is larger than a distance between downstream ends of neighbouring guiding beams. By such an arrangement, the guiding beams form a converging direction along a length of the guiding beams. Preferably, a converging direction corresponds to the direction of the arrangement of a central guiding beam. Preferably, a central guiding beam is a middle guiding beam of an odd total number of guiding beams. However, preferably a central guiding beam is arranged in the center of the sheet material laying on the central longitudinal axis of the sheet material.

A converging direction formed by the guiding beams is transferred onto the sheet material guided along or between and along the guiding beams. By this, not only a torsional movement of the sheet material is limited, the material is also further reduced in width at the same time as supporting the formation of an organized structure.

According to a further aspect of the apparatus according to the invention, an odd total number of guiding beams is arranged next to each other. A width of an upstream end of at least one guiding beams is larger than a width of a downstream end of this guiding beam. Preferably, upstream ends of all guiding beams have a width larger than a width of downstream ends of the corresponding guiding beams.

With an odd number of guiding beams, for example three or more, a central guiding beam may provide a symmetry axis in the sheet material. Small downstream ends of guiding beams allow for a smooth guiding of the sheet material along and out of the guiding beams. Especially, since the material is further folded downstream of the guiding beams enough space is provided for the sheet material already when still being guided in or by the guiding beams.

According to a further aspect of the invention, there is provided an installation comprising the apparatus according to the invention and as described above. The apparatus is arranged between a crimping apparatus for providing the continuous sheet material with a crimping structure running in a longitudinal direction of the continuous sheet material and a rod making machine. Therein, a length of the first roller and a length of the second roller is smaller than a width of an outlet of the crimping apparatus and is larger than a width of an inlet of the rod making machine.

The apparatus according to the invention thus receives the crimped sheet material from the crimping apparatus and then feeds the sheet material, which is now provided with the overlaying wave-like structure, into the rod-making machine. By this, the sheet material may be crimped and continuously be folded from a flat shape to a final rod shape. In addition, by arranging the apparatus according to the invention between a crimping apparatus and a rod making machine, a rod-forming process as known and used for example in the tobacco industries for the manufacture of filter elements may be improved without having to change previous and following processes or machine parts. The apparatus according to the invention may be inserted into existing manufacturing installations for improvement of the manufacture of rod-shaped articles.

The method and apparatus according to the invention is preferably used in the manufacture of filter elements for smoking articles such as for example cigarettes or other aerosol-generating articles such as for example used in electronic devices.

Further advantageous aspects of the method and apparatus according to the invention become apparent from the following description of embodiments with the aid of the drawings in which:

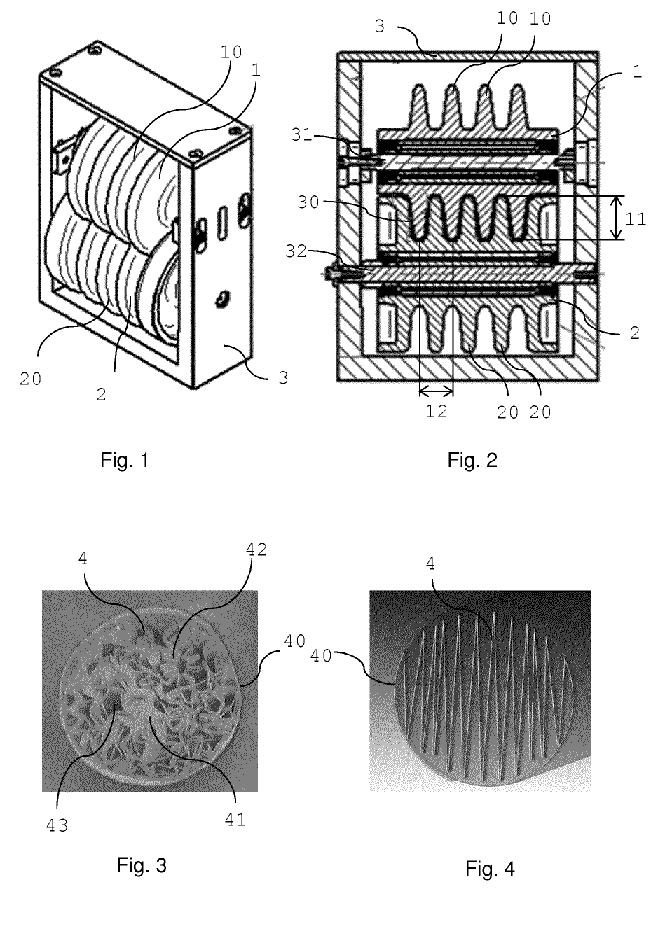

FIG. 1 is a perspective view of an apparatus according to the invention;

FIG. 2 is a cross section of the apparatus of FIG. 1 taken along a middle plane cutting through and along a central axis of the first and the second roller;

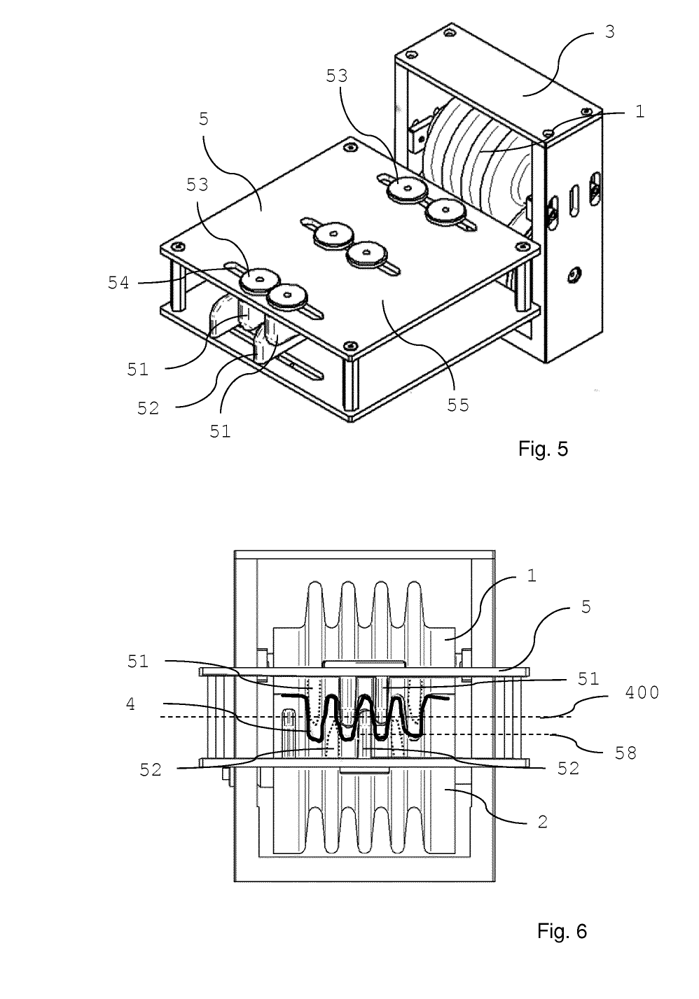

FIGS. 3, 4 show cross sections through a rod-shaped article with a structure of random order (FIG. 3) and with optimized order (FIG. 4);

FIG. 5 is the apparatus according to FIG. 1 provided with an anti-rotation unit;

FIG. 6 is a front view of the apparatus according to the invention according to FIG. 5;

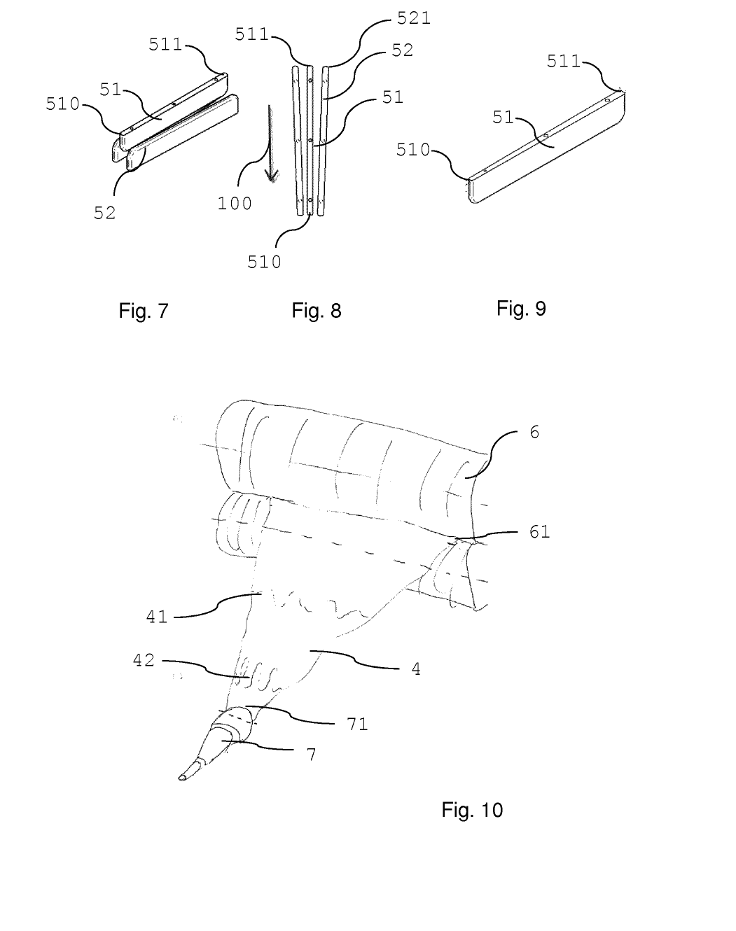

FIGS. 7, 8 are a perspective and a top view of guiding beam arrangements;

FIG. 9 shows an embodiment of a guiding beam;

FIG. 10 is a schematic view of a treating process of continuous sheet material into a rod-shape.

In FIG. 1 and FIG. 2 a first roller 1 and a second roller 2 are arranged above each other and held in a frame 3 via corresponding axles 31, 32 of first and second roller 1,2. First roller 1 and second roller 2 are each provided with a plurality of circumferentially running cams 10, 20. The cams 10,20 of each roller 1,2 are arranged parallel to each other and are regularly distributed along the length of each roller 1,2.

First and second roller 1,2 are arranged such that circumferentially running cams 10 of first roller 1 and circumferentially running cams of second roller 2 engage each other. The rollers are also arranged such as to form a gap 30 between the cams 10,20 of first and second roller 1,2. Preferably, the form of the cams 10 of the first roller 1 and the form of the cams 20 of the second roller 2 correspond to each other such as to form a constant gap 30 along the length of the rollers 1,2 upon engaging cams 10,20. A height 11 of the cams 10,20, that is, a distance between wave peak and wave trough may be between about 25 mm and about 30 mm, for example 28 mm and a cam to cam distance (distance from wave peak to wave peak) may be between about 15 mm and about 25 mm, for example 20 mm, for a circular shape to be formed by the sheet material at the entrance of a rod-making machine, which entrance has a circular diameter of about to 25 mm to about 30 mm, for example 27 mm.

By a vertical adjustment of one or both of the rollers 1,2 or by replacing first roller 1 or second roller 2, the width of gap 30 or a form of gap 30 may be adjusted. Gap 30 is adjusted to allow a sheet of material to pass between the first and second roller 1,2. Gap 30 is also adjusted to force a wave-like structure corresponding to the form of the engaging cams 10,20 of first and second rollers 1,2 into the continuous sheet material guided between the cams. The shape of gap 30 may be designed in order to guarantee that sheet material 4 with a predetermined width can completely fit the wave design of the cams 10,20 of the rollers. Preferably, sheet material extends along the entire length of the rollers 1,2 and no material escapes outside of the rollers during manufacturing. Preferably, a gap 30 is further adjusted depending on a thickness and a stiffness of a sheet material to be treated. Preferably, a gap between the cams of the two rollers is in a range between about 0.2 mm and about 3 mm, more preferably between about 0.25 mm and 2 mm, for example between 0.5 mm and 1.5 mm.

Upon guiding the continuous sheet material between first and second rollers 1,2 the rollers are made to roll around axles 31,32 by the frictional force between sheet material and cams 10,20. Thereby, a sliding friction that would act on the sheet material when using a stationary member for providing a wave-like structure may be avoided or minimized through the provision of two cooperating rollers rolling in or counter a direction of transport of the sheet material, respectively. The force acting on the sheet material due to the rollers is located and limited to the region where first and second rollers 1,2 engage. This engaging region is basically limited to a line arranged in a transversal direction of the direction of transport of the sheet material.

Axles 31,32 may also be driven by an external motor and a rotational speed of the rollers 1,2 may be synchronized with a linear (transport) speed of the sheet material guided between the rollers.

FIG. 3 shows a cross section through a rod-shaped article 40 with a structure of random order. This rod-shaped article has been manufactured by pushing together a continuous flat sheet material comprising a crimping structure but no overlaying wave-like structure into a rod shape as known in the art. Due to the uncontrolled folding of the sheet material the final product shows regions 41 of dense sheet material, regions 42 with a loose arrangement of sheet material and regions 43 with no sheet material (voids). Filter elements produced in this manner have specifications, for example a resistance to draw, which are hard to be defined precisely. In addition, due to the random order also a reproducibility of filter elements having the same specifications is challenged. This may especially affect smoking articles comprising several segments, wherein each segment may be shorter than in conventional smoking articles. It may also affect a product, where more effective material allows for the production of shorter segments.

FIG. 4 shows a cross section through a rod-shaped article 40 with a sheet material 4 folded with the method according to the invention having a structure with optimized order. It can be noticed from the figure the improvements from FIG. 3 with reduced voids and a better general distribution.

In FIG. 5 an anti-rotation unit 5 is arranged next to and downstream (downstream with respect to the direction of transport of the sheet material) of first and second rollers 1,2. Anti-rotation unit 5 comprises two upper guiding beams and one lower guiding beam 52 arranged between the two upper guiding beams 51. The upper and the lower guiding beam 51,52 are arranged with an offset in opposite directions perpendicular to a movement plane of the sheet material, wherein the sheet material is guided along and between the guiding beams. Guiding beams 51,52 are arranged with their longitudinal axes essentially arranged in the direction of transport of the sheet material. Additional guiding beams may be arranged next to the guiding beams 51,52 to have more guiding for the remaining path of crimped material.

Guiding beams 51,52 are mounted to support frame 55. Support frame 55 comprises slits 54, wherein guiding beams 51,52 are movably arrangeable in and fixed via fixing means 53, for example screws. Slits 54 allow for a sideways or transversal (transversal with respect to a direction of transport of the sheet material) shifting of the guiding beams 51,52. This allows for a varying of a lateral distance of and between the guiding beams. Such a distance between guiding beams 51,52 may be constant along the length of the guiding beams or may, as in the drawing, be reduced with increasing distance to rollers 1,2. In other words, upstream ends 511,521 of neighbouring guiding beams 51,52 are further distanced from each other than downstream ends 510,520 of neighbouring guiding beams. By this, the guiding beams describe a converging direction, as can also be seen in FIG. 8. Therein the direction of transport of the sheet material is indicated by arrow 100 (one upper guiding beam 51 and two lower guiding beams 52 are shown). When guiding the sheet material provided with the wave-like structure through the treatment by first and second rollers 1,2 along and between the three guiding beams 51,52, the wave-like structure is taken over by the arrangement of the guiding beams. Upper and lower guiding beams alternatively interact with the waveform of the wave-like structure of the sheet material. On one hand this stabilises the sheet material having the wave-like structure against a rotational movement (through the longitudinal sidewall-like arrangement of the guiding beams) while being further processed. On the other hand this enables a further folding of the sheet material (through reduction of its width) in a guided manner.

In FIG. 6 the sheet material 4 as being processed in the anti-rotation unit 5 is shown in a front view. Anti-rotation unit 5 is arranged parallel to first and second roller 1,2 at a location such that sheet material 4 leaving gap 30 of first and second roller 1,2 is fed between guiding beams 51,52 of anti-rotation unit 5 preferably by a linear and straight movement. Upper and lower guiding beams are arranged with an offset 58 from the movement plane 400 of the sheet material 4. The offset 58 is indicated for the lower guiding beam 52 only.

Next to the two upper 51 and one lower guiding beam 52 further guiding beams may be arranged as indicated by dotted lines. The further upper and lower guiding beams 51,52 are also arranged in an alternating manner. The total number of guiding beams 51,52 is odd to provide symmetry with respect to the longitudinal axis of the lower centrally arranged guiding beam 52.

In FIG. 7 three guiding beams 51,52 are arranged in a converging manner in a transversal direction (transversal with respect to the sheet material) similar to FIG. 5. Guiding beams 51,52 are also arranged in a converging manner with respect to the movement plane 400 of sheet material 4. An offset 58 of the guiding beams with respect to movement plane 400 is larger at the downstream end 510 of the guiding beams than at the upstream end 511. Guiding beams may also have a constant width as shown in FIG. 7 or have a varying width over the length of the guiding beam 51, preferably have a smaller width at a downstream end 510 than at an upstream end 511 as shown in FIG. 9.

In FIG. 10 a schematic view of a treating process of continuous sheet material 4 into rod-shape as preferably used in the manufacture of smoking articles or elements of smoking articles such as filter elements is shown. For the sake of clarity the apparatus according to the invention has been omitted. However, the wave-like structure 41 provided in the sheet material 4 as well as the structure developing while further folding sheet material 4 into rod shape is indicated by lines 41,42. Flat continuous sheet material 4 is processed and provided with a crimping structure running in a longitudinal direction of the continuous sheet material while being guided through two crimping rollers 6. For providing the crimping structure the surface of one or both crimping rollers 6 may be provided with protrusions, ridges, cutting edges, crests and troughs etc. as known in the art.

A rod-making garniture or machine, for example comprising a garniture tongue and a jet air 7, is arranged further downstream of crimping rollers 6 in a direction of transport of the sheet material 4. On its path between crimping rollers 6 and inlet 71 of jet air 7, continuous sheet material 4 is folded from the flat shape into the rod shape defined by the jet air 7. The apparatus according to the invention is arranged between crimping rollers 6 and rod-jet air 7 for providing sheet material 4 with wave-like structure 41. The widths of first and second rollers 1,2 of the apparatus according to the invention are smaller than a width of an outlet 61 of crimping rollers 6 and are larger than a width of an inlet 71 of jet air 7. Preferably, a width of first and second rollers 1,2 is adapted to the width of sheet material 4 and to the longitudinal position of the rollers 1,2 between the crimping roller 6 and the jet air 7 (longitudinal with respect to the distance between crimper and rod making machine). This allows for a continuous folding of sheet material 4 without abrupt changes in width or flow direction and therefore to reduce stress in sheet material 4 upon its treatment. Preferably, a width of originally flat sheet material 4 (flat including crimping structure) is such that after insertion of the sheet material between the cam rollers, the material extends to both ends of the rollers to make use of the entire length of the rollers. However, the sheet material does preferably not exceed the ends of the rollers to prevent uncontrolled pushing together of the sheet material and having sheet material not provided with the wave-like structure. After providing the sheet material 4 with the wave-like structure 41, the sheet material is folded according to the wave-like structure and in a structured manner brought into its final rod shape in the rod-making machine.

1. Method for treating continuous sheet material for use in the manufacture of rod-shaped articles, the method comprising the steps of:
providing a continuous sheet material comprising a crimping structure, the crimping structure running in a longitudinal direction of the continuous sheet material;
providing a first roller and a second roller, the first roller and the second roller comprising a plurality of circumferentially running cams, the circumferentially running cams of the first roller and the circumferentially running cams of the second roller engaging each other;
guiding the continuous sheet material comprising the crimping structure between the circumferentially running cams of the first roller and of the second roller, thereby providing the continuous sheet material comprising the crimping structure running in the longitudinal direction with a wave-like structure, the wave-like structure running in a longitudinal direction of the continuous sheet material and the wave-like structure overlaying the crimping structure.

2. Method according to claim 1, wherein providing the continuous sheet material comprising the crimping structure with a wave-like structure comprises providing the continuous sheet material with a wave-like structure having wave peak to wave trough dimensions in the range of between about 10 mm and about 50 mm.

3. Method according to claim 1, further comprising the step of limiting a torsional movement of the continuous sheet material comprising the crimping structure and comprising the wave-like structure.

4. Method according to claim 3, wherein limiting a torsional movement of the continuous sheet material is performed by guiding the continuous sheet material comprising the crimping structure and comprising the wave-like structure between and along guiding beams, which guiding beams act on a central portion of the continuous sheet material.

5. Method according to claim 3, further comprising the step of reducing the width of the continuous sheet material upon performing the step of limiting the torsional movement of the sheet material.

6. Method according to claim 1, further comprising the step of feeding the continuous sheet material comprising the crimping structure and comprising the wave-like structure into a rod making machine.

7. Method according to claim 1, wherein a continuous sheet material made of a plastic material such as cellulose acetate is provided.

8. Apparatus for treating continuous sheet material comprising a crimping structure for use in the manufacture of rod-shaped articles, the apparatus comprising a first roller and a second roller, the first roller and the second roller each comprising a plurality of circumferentially running cams, wherein the first roller and the second roller are arranged to enable the circumferentially running cams of the first roller and the circumferentially running cams of the second roller to engage each other for providing the continuous sheet material comprising the crimping structure with a wave-like structure overlaying the crimping structure and running in a longitudinal direction of the continuous sheet material upon guiding the continuous sheet material comprising the crimping structure between the circumferentially running cams of the first roller and the circumferentially running cams of the second roller.

9. Apparatus according to claim 8, comprising a gap of a constant width arranged between the circumferentially running cams of the first roller and the circumferentially running cams of the second roller.

10. Apparatus according to claim 8, wherein a distance between neighbouring circumferentially running cams of the first roller ranges between about 5 mm and about 40 mm.

11. Apparatus according to any one of claim 8, further comprising guiding beams, each having a longitudinal axis, the guiding beams being arranged with their longitudinal axis in a direction of transport of the continuous sheet material for guiding of the continuous sheet material comprising the crimping structure and comprising the wave-like structure along the guiding beams in the direction of transport, thereby limiting a torsional movement of the sheet material.

12. Apparatus according to claim 11, the guiding beams further being arranged next to each other and at a preset distance to each other and further being arranged with an offset perpendicular to a movement plane of the continuous sheet material, neighbouring guiding beams having an offset in directions opposite each other to enable guiding of the continuous sheet material comprising the crimping structure and comprising the wave-like structure in between and along the guiding beams in a wave-like manner in the direction of transport.

13. Apparatus according to claim 11, wherein the guiding beams are arranged with a distance between upstream ends of neighbouring guiding beams being larger than a distance between downstream ends of neighbouring guiding beams.

14. Apparatus according claim 11, wherein an odd total number of guiding beams is arranged next to each other, and wherein a width of an upstream end of at least one guiding beam is larger than a width of a downstream end of this guiding beam.

15. Installation comprising an apparatus according to claim 8, wherein the apparatus is arranged between a crimping apparatus for providing the continuous sheet material with a crimping structure running in a longitudinal direction of the continuous sheet material and a rod making machine, and wherein a length of the first roller and a length of the second roller is smaller than a width of an outlet of the crimping apparatus and is larger than a width of an inlet of the rod making machine.

16. The apparatus according to claim 8, wherein the rod-shaped articles comprise filter elements for smoking articles.

17. Method according to claim 2, further comprising the step of limiting a torsional movement of the continuous sheet material comprising the crimping structure and comprising the wave-like structure.

18. Method according to claim 4, further comprising the step of reducing the width of the continuous sheet material upon performing the step of limiting the torsional movement of the sheet material.

19. Apparatus according to claim 9, wherein a distance between neighbouring circumferentially running cams of the first roller ranges between about 5 mm and about 40 mm.

20. Apparatus according to claim 9, further comprising guiding beams, each having a longitudinal axis, the guiding beams being arranged with their longitudinal axis in a direction of transport of the continuous sheet material for guiding of the continuous sheet material comprising the crimping structure and comprising the wave-like structure along the guiding beams in the direction of transport, thereby limiting a torsional movement of the sheet material
